(19) United States
(12) Patent Application Publication
(10) Pub. No.: US 2022/0375118 A1
(43) Pub. Date: Nov. 24, 2022

(54) METHOD AND APPARATUS FOR IDENTIFYING VEHICLE CROSS-LINE, ELECTRONIC DEVICE AND STORAGE MEDIUM

(71) Applicant: Beijing Baidu Netcom Science Technology Co., Ltd., Beijing (CN)

(72) Inventors: Yingying LI, Beijing (CN); Xinyi DAI, Beijing (CN); Xiao TAN, Beijing (CN); Hao SUN, Beijing (CN)

(21) Appl. No.: 17/880,931

(22) Filed: Aug. 4, 2022

Related U.S. Application Data
(63) Continuation of application No. PCT/CN2022/075117, filed on Jan. 29, 2022.

(30) Foreign Application Priority Data
Jun. 28, 2021 (CN) 202110718240.5

(51) Int. Cl. G06T 7/70; G06V 20/17; G06V 20/54

(52) U.S. Cl. CPC G06T 7/70; G06V 20/17; G06V 20/54; G06V 2201/08; G06V 2201/07; G06T 2207/30236; G06T 2207/10032

(57) ABSTRACT

Provided is a method and apparatus for identifying a vehicle cross-line. The method may include: determining, in each road condition image of a plurality of road condition images, position information of a target lane line and position information of a target vehicle; determining, based on the position information of the target lane line and the position information of the target vehicle, a relative positional relationship between the target vehicle and the target lane line corresponding to the each road condition image; and determining that the target vehicle crosses the line, if the relative positional relationships corresponding to the plurality of road condition images meet a preset condition.

This patent application is a continuation of International Application No. PCT/CN2022/075117, filed on Jan. 29, 2022, which claims priority to Chinese Patent Application No. 202110718240.5, filed on Jun. 28, 2021, and entitled “Method and Apparatus for Identifying Vehicle Cross-line, Electronic Device and Storage Medium”, the entirety of which is incorporated by reference herein.

### TECHNICAL FIELD

The present disclosure relates to the field of artificial intelligence, particularly to computer vision and deep learning technologies, and in particular may be used in smart city and intelligent transportation scenarios.

### BACKGROUND

In intelligent transportation scenarios, it is necessary to analyze vehicle violations. A solid line lane change is one of the more important violations. Identifying a solid line lane change requires judging whether a vehicle crosses the line.

### SUMMARY

The present disclosure provides a method and apparatus for identifying a vehicle cross-line, an electronic device and a storage medium.

According to an aspect of the present disclosure, a method for identifying a vehicle cross-line is provided, including: determining, in each road condition image of a plurality of road condition images, position information of a target lane line and position information of a target vehicle; determining, based on the position information of the target lane line and the position information of the target vehicle, a relative positional relationship between the target vehicle and the target lane line corresponding to the each road condition image; and determining that the target vehicle crosses the line, if the relative positional relationships corresponding to the plurality of road condition images meet a preset condition.

According to another aspect of the present disclosure, an apparatus for identifying a vehicle cross-line is provided, including: a position information determining module, configured to determine, in each road condition image of a plurality of road condition images, position information of a target lane line and position information of a target vehicle; a relative positional relationship determining module, configured to determine, based on the position information of the target lane line and the position information of the target vehicle, a relative positional relationship between the target vehicle and the target lane line corresponding to the each road condition image; and an identifying module, configured to determine that the target vehicle crosses the line, if the relative positional relationships corresponding to the plurality of road condition images meet a preset condition.

According to another aspect of the present disclosure, an electronic device is provided, including: at least one processor; and a memory communicatively connected to the at least one processor. The memory stores instructions executable by the at least one processor, and the instructions, when executed by the at least one processor, cause the at least one processor to perform the method for identifying a vehicle cross-line according to any embodiment of the present disclosure.

According to another aspect of the present disclosure, a non-transitory computer readable storage medium storing computer instructions is provided. The computer instructions are used to cause the computer to perform the method for identifying a vehicle cross-line according to any embodiment of the present disclosure.

It should be understood that contents described in this section are neither intended to identify key or important features of embodiments of the present disclosure, nor intended to limit the scope of the present disclosure. Other features of the present disclosure will become readily understood in conjunction with the following description.

### BRIEF DESCRIPTION OF THE DRAWINGS

The accompanying drawings are used for better understanding of the present solution and do not constitute a limitation to the present disclosure.

FIG. 1 is a schematic diagram of a method for identifying a vehicle cross-line provided according to an embodiment of the present disclosure;

FIG. 2 is a schematic diagram of the method for identifying a vehicle cross-line provided according to another embodiment of the present disclosure;

FIG. 3 is a schematic diagram of the method for identifying a vehicle cross-line provided according to another embodiment of the present disclosure;

FIG. 4 is a schematic diagram of an apparatus for identifying a vehicle cross-line provided according to an embodiment of the present disclosure;

FIG. 5 is a schematic diagram of the apparatus for identifying a vehicle cross-line provided according to another embodiment of the present disclosure; and

FIG. 6 is a block diagram of an electronic device used to implement the method for identifying a vehicle cross-line according to embodiments of the present disclosure.

### DETAILED DESCRIPTION OF EMBODIMENTS

Example embodiments of the present disclosure are described below with reference to the accompanying drawings, where various details of embodiments of the present disclosure are included to facilitate understanding, and should be considered merely as examples. Therefore, those of ordinary skills in the art should realize that various changes and modifications can be made to the embodiments described herein without departing from the scope and spirit of the present disclosure. Similarly, for clearness and conciseness, descriptions of well-known functions and structures are omitted in the following description.

FIG. 1 is a flowchart of a method for identifying a vehicle cross-line according to an embodiment of the present disclosure. As shown in FIG. 1, the method may include the following steps.

S101, determining, in each road condition image of a plurality of road condition images, position information of a target lane line and position information of a target vehicle.

S102, determining, based on the position information of the target lane line and the position information of the target vehicle, a relative positional relationship between the target vehicle and the target lane line corresponding to the each road condition image.

S103, determining that the target vehicle crosses a line, if the relative positional relationships corresponding to the plurality of road condition images meet a preset condition.

In step S101, for example, an image collecting device may be used to photograph the road condition images. The image collecting device is, for example, a drone or a camera on the road, such as a ball machine or a gun machine.

For example, the target vehicle may be any vehicle, a designated vehicle, or each detected vehicle. The target lane line may be any lane line, a designated lane line, or each detected lane line. The target lane line may also be a lane line related to the target vehicle, such as a lane line closest to the target vehicle. Therefore, the target lane line may also be determined based on the target vehicle.

For example, the position information of the target vehicle may be coordinates of a center point of the vehicle or a predetermined corner point in the vehicle in an image coordinate system. The position information of the target lane line may be a curve equation or a straight line equation in the image coordinate system.

In step S102, for example, the relative positional relationship between the target vehicle and the target lane line may be used to represent that the target vehicle is on the left or right side of the target lane line. After determining the position information of the target lane line and the position information of the target vehicle, it is then judged whether the target vehicle is located on the left or right side of the target lane line, so as to facilitate the determination of whether the target vehicle crosses the line.

In step S103, for example, the preset condition includes: the relative positional relationships corresponding to the plurality of road condition images are opposite. For example, in some road condition images, the target vehicle is located on the left side of the target lane line; in other road condition images, the target vehicle is located on the right side of the target lane line; in this way, it may be determined that the relative positional relationships corresponding to the plurality of road condition images meet the preset condition.

For example, by comparing the relative positional relationship between the target vehicle and the target lane line in a first road condition image and the relative positional relationship between the target vehicle and the target lane line in a second road condition image, if the relative positional relationship in the first road condition image is opposite to the relative positional relationship in the second road condition image, it may be determined that the target vehicle crosses the line.

In the technical solution of the present disclosure, based on the position information of the target vehicle and the position information of the target lane line in each road condition image, the relative positional relationship between the target vehicle and the target lane line in each road condition image can be accurately determined. Then, it may be determined whether the target vehicle crosses the line based on accurate relative positional relationships corresponding to the plurality of road condition images. Since the judgment is made by integrating the plurality of road condition images and based on the accurate relative positional relationships, the accuracy of identifying the target vehicle crossing the line can be improved.

In an embodiment, the method further includes: collecting the plurality of road condition images using a drone.

For example, the image collecting device may be a drone, and the drone may be used to continuously take pictures of a road condition in a high-speed scenario, thereby acquiring a plurality of consecutive road condition images. The drone may also be used to camera a road condition in a high-speed scenario to obtain a video, and acquire a plurality of frames of road condition video image frames in the video. Compared to fitting a vehicle trajectory using a plurality of images, then determining whether the vehicle crosses the line based on a comparison result between the vehicle trajectory and the lane lines in a single image, the present solution can still accurately identify whether the target vehicle crosses the line based on the relative positional relationship in the case of the drone shaking.

In an embodiment, the above step S101 may include: determining, based on position information of the target lane line in a first road condition image of the plurality of road condition images and a preset tracking strategy, position information of the target lane line in a second road condition image of the plurality of road condition images.

For example, in a drone photographing scenario, a photographing offset distance between the first road condition image and the second road condition image (i.e., a drone offset distance) is less than a distance between two adjacent lane lines. The preset tracking strategy may determine a lane line having an offset between the position information in the second road condition image and the position information of the target lane line in the first road condition image less than a preset threshold as the target lane line in the second road condition image.

For example, the first road condition image and the second road condition image may be consecutive images, for example, the i^{th} road condition image and the i+1^{th} image.

Since a time interval between two successive road condition images collected by the image collecting device is short, for example, less than one second, the lane line may be tracked by processing two consecutive road condition images using the preset tracking strategy, so that the target lane line can be accurately identified in the second road condition image, which helps to determine the relative positional relationship between the target vehicle and the target lane line, thereby improving the accuracy of identifying the target vehicle crossing the line.

For example, in a process of lane line tracking, an ID is given to each lane line in the first road condition image, and by processing two successive road condition images using the tracking strategy, the ID may be tracked in the latter road condition image. If a new lane line appears in a next road condition image, a new ID is given. If a certain ID does not appear in all subsequent road condition images, it is considered that the lane line disappears, and the lane line is no longer tracked.

In an embodiment, the above step S103 may include: determining that the target vehicle crosses the line, if the relative positional relationship corresponding to M consecutive road condition images in the plurality of road condition images is opposite to the relative positional relationship corresponding to N consecutive road condition images in the plurality of road condition images;

where, the M road condition images are images prior to the N road condition images, and the M road condition images are continuous with the N road condition images; and M and N are both integers greater than or equal to 1.

Specifically, if the relative positional relationship corresponding to the M consecutive road condition images in the plurality of road condition images is a first relative positional relationship, for example, the target vehicle is on the left side of the target lane line, the relative positional relationship corresponding to the N consecutive road condition images in the plurality of road condition images is a second relative positional relationship, for example, the target vehicle is on the right side of the target lane line, and the first relative positional relationship is opposite to the second relative positional relationship, it is determined that the target vehicle crosses the line.

That is, the relative positional relationship corresponding to the M road condition images is the same, and the relative positional relationship corresponding to the N road condition images is the same, but the relative positional relationship corresponding to the M road condition images is different from the relative positional relationship corresponding to the N road condition images, then it is determined that the preset condition is met, and the target vehicle crosses the line.

For example, M and N may be the same or different.

For example, if the drone photographs five consecutive road condition images, the first relative positional relationship between the target vehicle and the target lane line in the first three (i.e., M=3) road condition images is that the target vehicle is located on the left side of the target lane line, the second relative positional relationship between the target vehicle and the target lane line in the latter two (i.e., N=2) road condition images is that the target vehicle is located on the right side of the target lane line, then it may be determined that the target vehicle crosses the line.

Since the relative positional relationship corresponding to the M consecutive road condition images and the relative positional relationship corresponding to the N consecutive road condition images are determined in the consecutive road condition images, it is ensured that the relative positional relationship between the target vehicle and the target lane line in the M consecutive road condition images is consistent, and the relative positional relationship between the target vehicle and the target lane line in the N consecutive road condition images is consistent, so that when the relative positional relationship between the target vehicle and the target lane line changes, it can be accurately identified whether the target vehicle crosses the line.

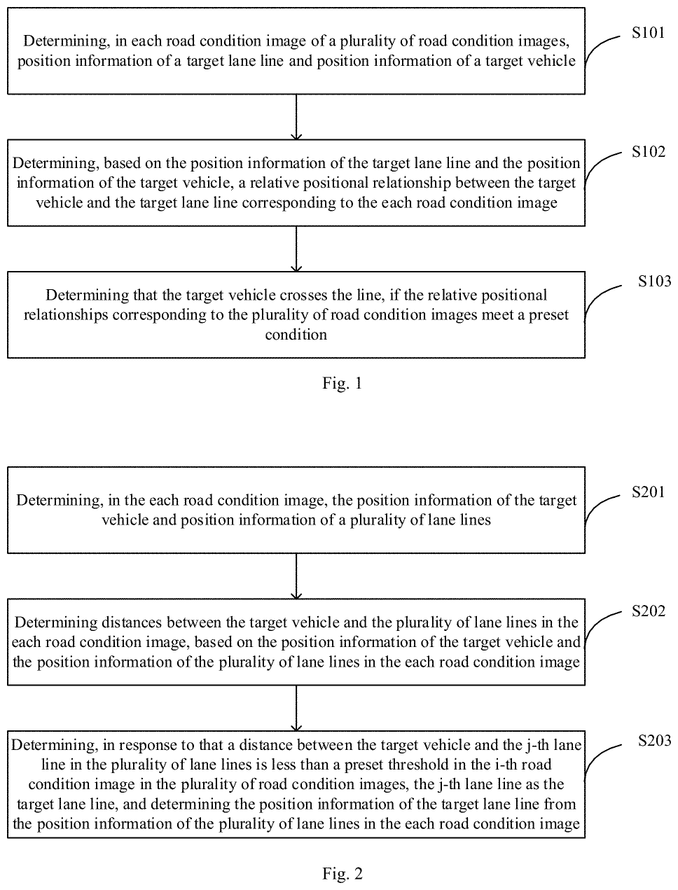

FIG. 2 is a flowchart of the method for identifying a vehicle cross-line according to another embodiment of the present disclosure. The method for identifying a vehicle cross-line of this embodiment may include the steps of the above embodiment. In the present embodiment, in S101, the determining, in each road condition image of a plurality of road condition images, position information of a target lane line and position information of a target vehicle, includes the following steps.

S201, determining, in the each road condition image, the position information of the target vehicle and position information of a plurality of lane lines;

S202, determining distances between the target vehicle and the plurality of lane lines in the each road condition image, based on the position information of the target vehicle and the position information of the plurality of lane lines in the each road condition image; and

S203, determining, in response to that a distance between the target vehicle and the j^{th} lane line in the plurality of lane lines is less than a preset threshold in the i^{th} road condition image in the plurality of road condition images, the j^{th} lane line as the target lane line, and determining the position information of the target lane line from the position information of the plurality of lane lines in the each road condition image; where, i and j are both integers greater than or equal to 1.

Specifically, after acquiring the road condition images photographed by the image collecting device, the road condition images are identified through instance segmentation (e.g., target detection, semantic segmentation, etc.), and the position information of the target vehicle and the position information of the plurality of lane lines are determined. The distances between the target vehicle and the plurality of lane lines are determined based on the position information of the target vehicle and the position information of the plurality of lane lines.

It may be understood that when the vehicle needs to cross the line, it needs to get close to the lane line. Therefore, when the distance between the target vehicle and any lane line is less than the preset threshold, the lane line is determined as the target lane line, so that the target lane line may be determined without determining all the relative positional relationship between the target vehicle and each lane line, thereby improving the efficiency of identifying vehicle cross-line. It should be noted that the preset threshold may be set according to actual needs, which is not limited herein.

In an embodiment, the above step S202 may include: determining the distances between the target vehicle and the plurality of lane lines in the each road condition image, based on a position of a center point of the target vehicle and straight line equations of the plurality of lane lines in the each road condition image.

For example, after instance segmentation is performed on each road condition image, the plurality of lane lines may be fitted respectively, so that each lane line can obtain a corresponding straight line equation. For example, y=ax+b. By calculating the position of the center point of the target vehicle and the straight line equations of the plurality of lane lines, it is convenient to calculate the distances between the target vehicle and the plurality of lane lines, so as to quickly determine the target lane line, and the accuracy of identifying the target vehicle crossing the line can be improved.

In an embodiment, the determining the position information of the target lane line from the position information of the plurality of lane lines in the each road condition image, includes: based on the position information of the j^{th} lane line (target lane line) in the i^{th} road condition image and the preset tracking strategy, the position information of the target lane line is selected from the position information of the plurality of lane lines in the i+1^{th} road condition image in the plurality of road condition images. The photographing offset distance between the i+1^{th} road condition image and the i^{th} road condition image is less than the distance between two adjacent lane lines.

For example, if there are five road condition images, after instance segmentation, it is determined that there are five lane lines in the first road condition image, the straight line equations of the five lane lines are determined respectively, and an ID is given to each lane line, and the IDs are set as 1, 2, 3, 4, 5, respectively. If the third lane line is close to the target vehicle in the first image, the position information of the third lane line is extracted from the latter four road condition images. In this way, the position information of the target lane line can be determined in each road condition image, which ensures that the target lane line can be accurately identified in each road condition image, thus, whether the target vehicle crosses the line can be accurately identified.

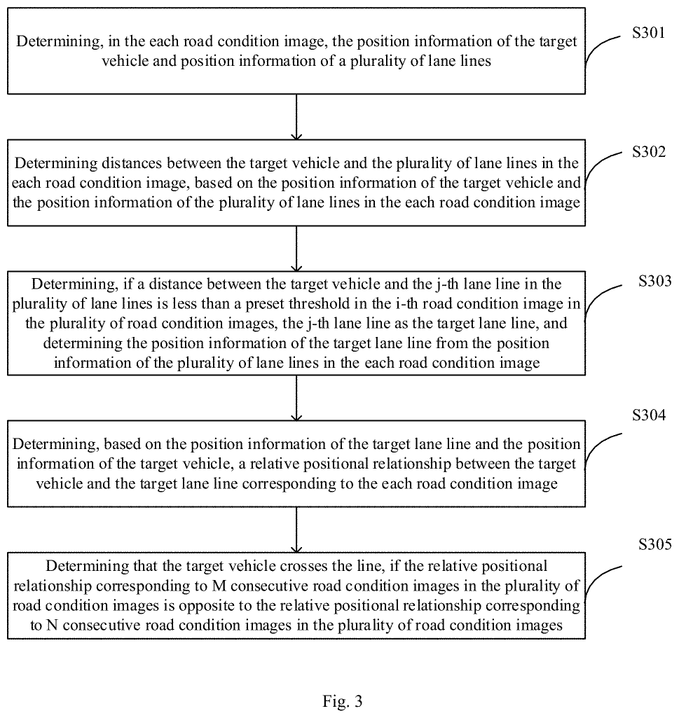

FIG. 3 is a flowchart of the method for identifying a vehicle cross-line according to another embodiment of the present disclosure. The method for identifying a vehicle cross-line of this embodiment may include the following steps.

S301, determining, in the each road condition image, the position information of the target vehicle and position information of a plurality of lane lines;

S302, determining distances between the target vehicle and the plurality of lane lines in the each road condition image, based on the position information of the target vehicle and the position information of the plurality of lane lines in the each road condition image; and

S303, determining, in response to that a distance between the target vehicle and the j^{th} lane line in the plurality of lane lines is less than a preset threshold in the i^{th} road condition image in the plurality of road condition images, the j^{th} lane line as the target lane line, and determining the position information of the target lane line from the position information of the plurality of lane lines in the each road condition image; where, i and j are both integers greater than or equal to 1.

Step 304, determining, based on the position information of the target lane line and the position information of the target vehicle, a relative positional relationship between the target vehicle and the target lane line corresponding to the each road condition image.

Step 305, determining that the target vehicle crosses the line, if the relative positional relationship corresponding to M consecutive road condition images in the plurality of road condition images is opposite to the relative positional relationship corresponding to N consecutive road condition images in the plurality of road condition images;

where, the M road condition images are images prior to the N road condition images, and the M road condition images are continuous with the N road condition images; and M and N are both integers greater than or equal to 1.

Specifically, if the relative positional relationship corresponding to the M consecutive road condition images in the plurality of road condition images is a first relative positional relationship, the relative positional relationship corresponding to the N consecutive road condition images in the plurality of road condition images is a second relative positional relationship, and the first relative positional relationship is opposite to the second relative positional relationship, it is determined that the target vehicle crosses the line; where, the M road condition images are images prior to the N road condition images, and the M road condition images are continuous with the N road condition images. Since the first relative positional relationship corresponding to the M consecutive road condition images and the second relative positional relationship corresponding to the N consecutive road condition images are determined in the consecutive road condition images, it is ensured that the relative positional relationship between the target vehicle and the target lane line in the M consecutive road condition images is consistent, and the second relative positional relationship in the N consecutive road condition images is consistent, so that based on the first relative positional relationship and the second relative positional relationship, it can be accurately identified whether the target vehicle crosses the line.

For example, after the drone photographs a plurality of road condition images, the road condition images are identified through instance segmentation (e.g., target detection, semantic segmentation, etc.), and a plurality of lane lines are fitted separately, so that each lane line can obtain a corresponding straight line equation. For example, y=ax+b. By calculating distances between the position of the center point of the target vehicle and the straight line equations corresponding to the plurality of lane lines, a lane line having a distance less than the preset threshold is selected as the target lane line, and the straight line equation corresponding to the target lane line is determined. On the basis that the first relative positional relationship between the target vehicle and the target lane line in the M consecutive road condition images in the plurality of road condition images is that the target vehicle is located on the left side of the target lane line, and the second relative positional relationship between the target vehicle and the target lane line in the N consecutive road condition images is that the target vehicle is located on the right side of the target lane line, and the M road condition images are continuous with the N road condition images, then it can be determined that the target vehicle crosses the line based on the first relative positional relationship and the second relative positional relationship.

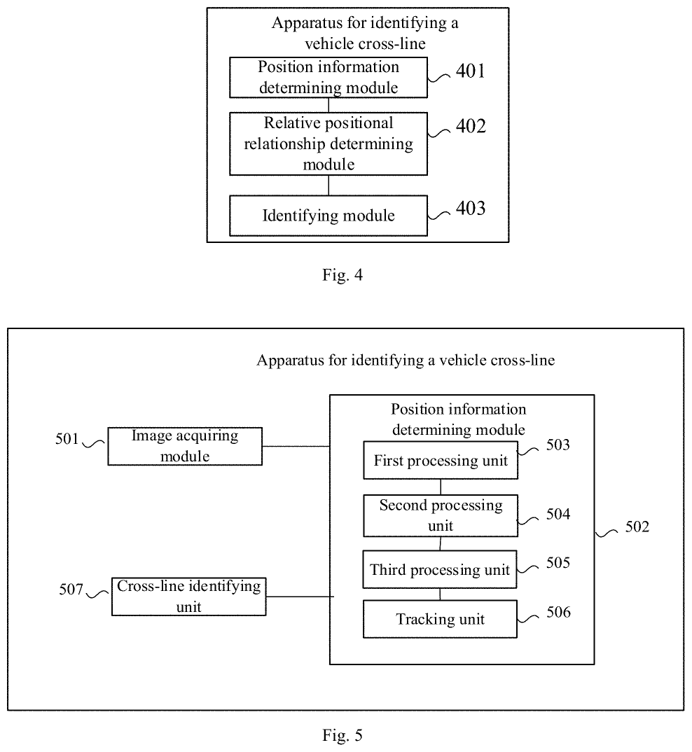

FIG. 4 is a block diagram of an apparatus for identifying a vehicle cross-line according to an embodiment of the present disclosure. As shown in FIG. 4, the apparatus may include: a position information determining module 401, configured to determine, in each road condition image of a plurality of road condition images, position information of a target lane line and position information of a target vehicle; a relative positional relationship determining module 402, configured to determine, based on the position information of the target lane line and the position information of the target vehicle, a relative positional relationship between the target vehicle and the target lane line corresponding to the each road condition image; and an identifying module 403, configured to determine that the target vehicle crosses the line, if the relative positional relationships corresponding to the plurality of road condition images meet a preset condition.

In an embodiment, as shown in FIG. 5, the apparatus further includes: an image acquiring module 501, configured to collect the plurality of road condition images using a drone.

In an embodiment, as shown in FIG. 5, a position information determining module 502, includes: a first processing unit 503, configured to determine, in the each road condition image, the position information of the target vehicle and position information of a plurality of lane lines; a second processing unit 504, configured to determine distances between the target vehicle and the plurality of lane lines in the each road condition image, based on the position information of the target vehicle and the position information of the plurality of lane lines in the each road condition image; and a third processing unit 505, configured to determine, in response to that a distance between the target vehicle and the j^{th} lane line in the plurality of lane lines is less than a preset threshold in the i^{th} road condition image in the plurality of road condition images, the j^{th} lane line as the target lane line, and determine the position information of the target lane line from the position information of the plurality of lane lines in the each road condition image; where, i and j are both integers greater than or equal to 1.

In an embodiment, as shown in FIG. 5, the position information determining module 502, includes: a tracking unit 506, configured to determine, based on position information of the target lane line in a first road condition image of the plurality of road condition images and a preset tracking strategy, position information of the target lane line in a second road condition image of the plurality of road condition images.

In an embodiment, as shown in FIG. 5, the identifying module includes: a cross-line identifying unit 507, configured to determine that the target vehicle crosses the line, if the relative positional relationship corresponding to M consecutive road condition images in the plurality of road condition images is opposite to the relative positional relationship corresponding to N consecutive road condition images in the plurality of road condition images; where, the M road condition images are images prior to the N road condition images, and the M road condition images are continuous with the N road condition images; and M and N are both integers greater than or equal to 1.

In an embodiment, the second processing unit is configured to: determine the distances between the target vehicle and the plurality of lane lines in the each road condition image, based on a position of a center point of the target vehicle and straight line equations of the plurality of lane lines in the each road condition image.

In this way, the apparatus according to an embodiment of the present disclosure can accurately determine the relative positional relationship between the target vehicle and the target lane line in each road condition image based on the position information of the target vehicle and the position information of the target lane line in each road condition image. Then, it may be determined whether the target vehicle crosses the line based on accurate relative positional relationships corresponding to the plurality of road condition images. Since the judgment is made by integrating the plurality of road condition images and based on the accurate relative positional relationships, the accuracy of identifying the target vehicle crossing the line can be improved.

In the technical solution of the present disclosure, the acquisition, storage, and application of the user personal information involved are all in compliance with the relevant laws and regulations, and do not violate public order and good customs.

According to an embodiment of the present disclosure, the present disclosure also provides an electronic device, a readable storage medium, and a computer program product.

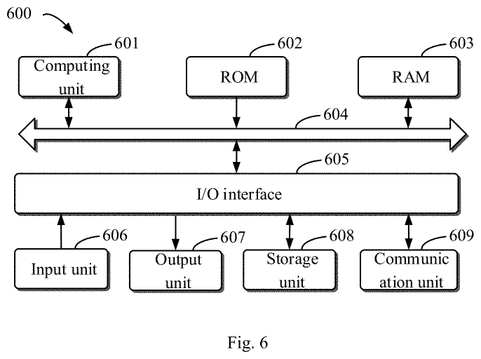

FIG. 6 illustrates a schematic block diagram of an example electronic device 600 for implementing the embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The components shown herein, their connections and relationships, and their functions are merely examples, and are not intended to limit the implementation of the present disclosure described and/or claimed herein.

As shown in FIG. 6, the device 600 includes a computing unit 601, which may perform various appropriate actions and processing, based on a computer program stored in a read-only memory (ROM) 602 or a computer program loaded from a storage unit 608 into a random access memory (RAM) 603. In the RAM 603, various programs and data required for the operation of the device 600 may also be stored. The computing unit 601, the ROM 602, and the RAM 603 are connected to each other through a bus 604. An input/output (I/O) interface 605 is also connected to the bus 604.

A plurality of parts in the device 600 are connected to the I/O interface 605, including: an input unit 606, for example, a keyboard and a mouse; an output unit 607, for example, various types of displays and speakers; the storage unit 608, for example, a disk and an optical disk; and a communication unit 609, for example, a network card, a modem, or a wireless communication transceiver. The communication unit 609 allows the device 600 to exchange information/data with other devices over a computer network such as the Internet and/or various telecommunication networks.

The computing unit 601 may be various general-purpose and/or dedicated processing components having processing and computing capabilities. Some examples of the computing unit 601 include, but are not limited to, central processing unit (CPU), graphics processing unit (GPU), various dedicated artificial intelligence (AI) computing chips, various computing units running machine learning model algorithms, digital signal processors (DSP), and any appropriate processors, controllers, microcontrollers, etc. The computing unit 601 performs the various methods and processes described above, such as a method for identifying a vehicle cross-line. For example, in some embodiments, a method for identifying a vehicle cross-line may be implemented as a computer software program, which is tangibly included in a machine readable medium, such as the storage unit 608. In some embodiments, part or all of the computer program may be loaded and/or installed on the device 600 via the ROM 602 and/or the communication unit 609. When the computer program is loaded into the RAM 603 and executed by the computing unit 601, one or more steps of the method for identifying a vehicle cross-line described above may be performed. Alternatively, in other embodiments, the computing unit 601 may be configured to perform a method for identifying a vehicle cross-line by any other appropriate means (for example, by means of firmware).

The various implementations of the systems and technologies described herein may be implemented in a digital electronic circuit system, an integrated circuit system, a field programmable gate array (FPGA), an application specific integrated circuit (ASIC), an application specific standard product (ASSP), a system-on-chip (SOC), a complex programmable logic device (CPLD), computer hardware, firmware, software and/or combinations thereof. The various implementations may include: being implemented in one or more computer programs, where the one or more computer programs may be executed and/or interpreted on a programmable system including at least one programmable processor, and the programmable processor may be a particular-purpose or general-purpose programmable processor, which may receive data and instructions from a storage system, at least one input device and at least one output device, and send the data and instructions to the storage system, the at least one input device and the at least one output device.

Program codes used to implement the method of embodiments of the present disclosure may be written in any combination of one or more programming languages. These program codes may be provided to a processor or controller of a general-purpose computer, particular-purpose computer or other programmable data processing apparatus, so that the program codes, when executed by the processor or the controller, cause the functions or operations specified in the flowcharts and/or block diagrams to be implemented. These program codes may be executed entirely on a machine, partly on the machine, partly on the machine as a stand-alone software package and partly on a remote machine, or entirely on the remote machine or a server.

In the context of the present disclosure, the machine-readable medium may be a tangible medium that may include or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any appropriate combination thereof. A more particular example of the machine-readable storage medium may include an electronic connection based on one or more lines, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof.

To provide interaction with a user, the systems and technologies described herein may be implemented on a computer having: a display device (such as a CRT (cathode ray tube) or LCD (liquid crystal display) monitor) for displaying information to the user; and a keyboard and a pointing device (such as a mouse or a trackball) through which the user may provide input to the computer. Other types of devices may also be used to provide interaction with the user. For example, the feedback provided to the user may be any form of sensory feedback (such as visual feedback, auditory feedback or tactile feedback); and input from the user may be received in any form, including acoustic input, speech input or tactile input.

The systems and technologies described herein may be implemented in: a computing system including a background component (such as a data server), or a computing system including a middleware component (such as an application server), or a computing system including a front-end component (such as a user computer having a graphical user interface or a web browser through which the user may interact with the implementations of the systems and technologies described herein), or a computing system including any combination of such background component, middleware component or front-end component. The components of the systems may be interconnected by any form or medium of digital data communication (such as a communication network). Examples of the communication network include a local area network (LAN), a wide area network (WAN), and the Internet.

A computer system may include a client and a server. The client and the server are generally remote from each other, and generally interact with each other through the communication network. A relationship between the client and the server is generated by computer programs running on a corresponding computer and having a client-server relationship with each other.

It should be appreciated that the steps of reordering, adding or deleting may be executed using the various forms shown above. For example, the steps described in embodiments of the present disclosure may be executed in parallel or sequentially or in a different order, so long as the expected results of the technical schemas provided in embodiments of the present disclosure may be realized, and no limitation is imposed herein.

The above particular implementations are not intended to limit the scope of the present disclosure. It should be appreciated by those skilled in the art that various modifications, combinations, sub-combinations, and substitutions may be made depending on design requirements and other factors. Any modification, equivalent and modification that fall within the spirit and principles of the present disclosure are intended to be included within the scope of the present disclosure.

What is claimed is:

1. A method for identifying a vehicle cross-line, the method comprising:
determining, in each road condition image of a plurality of road condition images, position information of a target lane line and position information of a target vehicle;
determining, based on the position information of the target lane line and the position information of the target vehicle, a relative positional relationship between the target vehicle and the target lane line corresponding to each road condition image; and
determining that the target vehicle crosses the target lane line if the relative positional relationships corresponding to the plurality of road condition images meet a preset condition.

2. The method according to claim 1, wherein determining that the target vehicle crosses the target lane line comprises:
determining that the target vehicle crosses the line if the relative positional relationship corresponding to M consecutive road condition images in the plurality of road condition images is opposite to the relative positional relationship corresponding to N consecutive road condition images in the plurality of road condition images;
wherein, the M consecutive road condition images are images prior to the N consecutive road condition images, and the M road condition images are continuous with the N road condition images; and M and N are both integers greater than or equal to 1.

3. The method according to claim 1, wherein determining position information of a target lane line and position information of a target vehicle comprises:
determining, in each road condition image, position information of the target vehicle and position information of a plurality of lane lines;
determining distances between the target vehicle and the plurality of lane lines in each road condition image based on the position information of the target vehicle and the position information of the plurality of lane lines in each road condition image; and
determining, in response to that a distance between the target vehicle and a j^{th} lane line in the plurality of lane lines is less than a preset threshold in an i^{th} road condition image in the plurality of road condition images, the j^{th} lane line as the target lane line, and determining the position information of the target lane line from the position information of the plurality of lane lines in each road condition image; wherein, i and j are both integers greater than or equal to 1.

4. The method according to claim 3, wherein determining distances between the target vehicle and the plurality of lane lines in each road condition image comprises:
determining the distances between the target vehicle and the plurality of lane lines in each road condition image, based on a position of a center point of the target vehicle and straight line equations of the plurality of lane lines in each road condition image.

5. The method according to claim 1, wherein, determining, in each road condition image of a plurality of road condition images, position information of a target lane line comprises:
determining, based on position information of the target lane line in a first road condition image of the plurality of road condition images and a preset tracking strategy, position information of the target lane line in a second road condition image of the plurality of road condition images.

6. The method according to claim 1, further comprising:
collecting the plurality of road condition images using a drone.

7. An electronic device, comprising:
at least one processor; and
a memory communicatively connected to the at least one processor;
wherein the memory is configured to store a plurality of instructions executable by the at least one processor, and the instructions, when executed by the at least one processor, cause the processor to perform operations comprising:
determining, in each road condition image of a plurality of road condition images, position information of a target lane line and position information of a target vehicle;
determining, based on the position information of the target lane line and the position information of the target vehicle, a relative positional relationship between the target vehicle and the target lane line corresponding to each road condition image; and
determining that the target vehicle crosses the line if the relative positional relationships corresponding to the plurality of road condition images meet a preset condition.

8. The electronic device according to claim 7, wherein determining that the target vehicle crosses the line if the relative positional relationships corresponding to the plurality of road condition images meet a preset condition comprises:
determining that the target vehicle crosses the line if the relative positional relationship corresponding to M consecutive road condition images in the plurality of road condition images is opposite to the relative positional relationship corresponding to N consecutive road condition images in the plurality of road condition images;
wherein, the M consecutive road condition images are images prior to the N consecutive road condition images, and the M road condition images are continuous with the N road condition images; and M and N are both integers greater than or equal to 1.

9. The electronic device according to claim 7, wherein determining position information of a target lane line and position information of a target vehicle comprises:
determining, in each road condition image, the position information of the target vehicle and position information of a plurality of lane lines;
determining distances between the target vehicle and the plurality of lane lines in each road condition image, based on the position information of the target vehicle and the position information of the plurality of lane lines in each road condition image; and
determining, in response to that a distance between the target vehicle and a j^{th} lane line in the plurality of lane lines is less than a preset threshold in an i^{th} road condition image in the plurality of road condition images, the j^{th} lane line as the target lane line, and determining the position information of the target lane line from the position information of the plurality of lane lines in each road condition image; wherein, i and j are both integers greater than or equal to 1.

10. The electronic device according to claim 9, wherein determining distances between the target vehicle and the plurality of lane lines in each road condition image comprises:
determining the distances between the target vehicle and the plurality of lane lines in the each road condition image, based on a position of a center point of the target vehicle and straight line equations of the plurality of lane lines in the each road condition image.

11. The electronic device according to claim 7, wherein determining, in each road condition image of a plurality of road condition images, position information of a target lane line comprises:
determining, based on position information of the target lane line in a first road condition image of the plurality of road condition images and a preset tracking strategy, position information of the target lane line in a second road condition image of the plurality of road condition images.

12. The electronic device according to claim 7, wherein the operations further comprise:
collecting the plurality of road condition images using a drone.

13. A non-transitory computer readable storage medium configured to store a plurality of computer instructions, wherein the computer instructions, when executed by a processor, cause the processor to perform operations comprising:
determining, in each road condition image of a plurality of road condition images, position information of a target lane line and position information of a target vehicle;
determining, based on the position information of the target lane line and the position information of the target vehicle, a relative positional relationship between the target vehicle and the target lane line corresponding to each road condition image; and
determining that the target vehicle crosses the line, if the relative positional relationships corresponding to the plurality of road condition images meet a preset condition.

14. The non-transitory computer readable storage medium according to claim 13, wherein determining that the target vehicle crosses the line if the relative positional relationships corresponding to the plurality of road condition images meet a preset condition comprises:
determining that the target vehicle crosses the line, if the relative positional relationship corresponding to M consecutive road condition images in the plurality of road condition images is opposite to the relative positional relationship corresponding to N consecutive road condition images in the plurality of road condition images;
wherein, the M consecutive road condition images are images prior to the N consecutive road condition images, and the M road condition images are continuous with the N road condition images; and M and N are both integers greater than or equal to 1.

15. The non-transitory computer readable storage medium according to claim 13, wherein determining position information of a target lane line and position information of a target vehicle comprises:
determining, in each road condition image, the position information of the target vehicle and position information of a plurality of lane lines;
determining distances between the target vehicle and the plurality of lane lines in each road condition image, based on the position information of the target vehicle and the position information of the plurality of lane lines in each road condition image; and
determining, in response to that a distance between the target vehicle and a j^{th} lane line in the plurality of lane lines is less than a preset threshold in an i^{th} road condition image in the plurality of road condition images, the j^{th} lane line as the target lane line, and determining the position information of the target lane line from the position information of the plurality of lane lines in each road condition image; wherein, i and j are both integers greater than or equal to 1.

16. The non-transitory computer readable storage medium according to claim 15, wherein determining distances between the target vehicle and the plurality of lane lines in each road condition image comprises:
determining the distances between the target vehicle and the plurality of lane lines in each road condition image, based on a position of a center point of the target vehicle and straight line equations of the plurality of lane lines in each road condition image.

17. The non-transitory computer readable storage medium according to claim 13, wherein determining, in each road condition image of a plurality of road condition images, position information of a target lane line comprises:
determining, based on position information of the target lane line in a first road condition image of the plurality of road condition images and a preset tracking strategy, position information of the target lane line in a second road condition image of the plurality of road condition images.

18. The non-transitory computer readable storage medium according to claim 13, wherein the operations further comprise:
collecting the plurality of road condition images using a drone.
